(19) United States
(12) Patent Application Publication
(10) Pub. No.: US 2020/0197141 A1
(43) Pub. Date: Jun. 25, 2020

(54) DENTAL CLEANING TOOL WITH ROTATABLE CLEANING INSTRUMENT

(71) Applicant: World Wide Daily Holdings Company Limited, Hong Kong (CN)

(72) Inventor: Chun Yuen TO, Hong Kong (CN)

(21) Appl. No.: 16/386,743

(22) Filed: Apr. 17, 2019

Related U.S. Application Data
(63) Continuation of application No. PCT/CN2018/122594, filed on Dec. 21, 2018.

(51) Int. Cl. A61C 15/04; A61C 15/02

(52) U.S. Cl. CPC A61C 15/046; A46B 2200/108; A61C 15/02

(57) ABSTRACT

A dental cleaning tool includes a handle defining a longitudinal axis. The handle has a first end and an opposing second end. The handle includes a first arm and a second arm defining a storage gap therebetween. The dental cleaning tool also includes a first cleaning instrument attached to the first end of the handle and a second cleaning instrument at the second end of the handle. The second cleaning instrument is positionable relative to the handle between a stowed position in which the second cleaning instrument is positioned in the storage gap between the first and second arms and an operable position in which the second cleaning instrument extends beyond the second end of the handle.

### FIELD

The field of this disclosure relates generally to a dental cleaning tool having at least one rotatable cleaning instrument and a handle defining a storage gap for selectively stowing the at least one cleaning instrument.

### BACKGROUND

Dental cleaning tools are used to remove food remnants and/or build-up from the surface of or between teeth. As a result, some known dental cleaning tools include a brush for cleaning the surface of teeth, and other known dental cleaning tools include floss and/or a pick for removing or loosening food remnants (or other debris) lodged between the user's teeth. Moreover, at least some known dental cleaning tools include a cleaning instrument that may be positioned in a stowed position. However, many known dental cleaning tools implement bulky and complex mechanical means for shielding the cleaning instrument when in the stowed position. In addition, the dental cleaning tool may include one or more components that are separate from the rest of the dental cleaning tool and may be lost when deployed from the dental cleaning tool.

Therefore, there is a need for a simple and cost effective dental cleaning tool having a selectable cleaning instrument.

### BRIEF DESCRIPTION

In one aspect, a dental cleaning tool includes a handle defining a longitudinal axis and a storage gap. The handle has a first end and an opposing second end. The dental cleaning tool includes a first cleaning instrument extending from the first end of the handle. The dental cleaning tool also includes a second cleaning instrument positionable between a stowed position in which the second cleaning instrument is positioned within the storage gap and an operable position in which the second cleaning instrument extends from second end of the handle. The dental cleaning tool further includes a third cleaning instrument positionable between a stowed position in which the third cleaning instrument is positioned within the storage gap and an operable position in which the third cleaning instrument extends from the second end of the handle. The dental cleaning tool also includes a connector having a first end and an opposing second end and defining a connector axis. The second cleaning instrument is connected to the first end of the connector and the third cleaning instrument is connected to the second end of the connector. The connector is rotatably connected to the handle for selectively positioning the second cleaning instrument and the third cleaning instrument relative to the handle. The second cleaning instrument is in the operable position when the third cleaning instrument is in the stowed position and the third cleaning instrument is in the operable position when the second cleaning instrument is in the stowed position.

In another aspect, a dental cleaning tool includes a handle defining a longitudinal axis. The handle has a first end and an opposing second end. The handle includes a first arm and a second arm defining a storage gap therebetween. The dental cleaning tool also includes a first cleaning instrument attached to the first end of the handle and a second cleaning instrument at the second end of the handle. The dental cleaning tool further includes a rotational joint attaching the second cleaning instrument to the handle. The rotational joint allows the second cleaning instrument to rotate relative to the handle for selective positioning of the second cleaning instrument between a stowed position in which the second cleaning instrument is positioned in the storage gap between the first and second arms and an operable position in which the second cleaning instrument extends beyond the second end of the handle. The dental cleaning tool also includes a retaining mechanism configured to retain the second cleaning instrument in at least one of the operable position and the stowed position.

In yet another aspect, a method for assembling a dental cleaning tool includes providing a handle defining a longitudinal axis and a storage gap. The handle has a first end and an opposing second end. The method also includes attaching a first cleaning instrument to the first end of the handle. The method also includes attaching a second cleaning instrument to a first end of a connector. The second cleaning instrument is positionable between a stowed position in which the second cleaning instrument is positioned within the storage gap and an operable position in which the second cleaning instrument extends from second end of the handle. The method further includes attaching a third cleaning instrument to a second end of the connector. The third cleaning instrument is positionable between a stowed position in which the third cleaning instrument is positioned within the storage gap and an operable position in which the third cleaning instrument extends from the second end of the handle. The method also includes rotatably connecting the connector to the handle to allow the second cleaning instrument and the third cleaning instrument to rotate relative to the handle.

### BRIEF DESCRIPTION OF THE DRAWINGS

FIG. 1 is a perspective view of a dental cleaning tool having first, second, and third cleaning instruments attached to a handle, the second and third cleaning instruments being rotatable relative to the handle;

FIG. 2 is an upper perspective view of the dental cleaning tool with the second cleaning instrument in an operable position;

FIG. 3 is a front side view of the dental cleaning tool with the second cleaning instrument in the operable position;

FIG. 4 is a back side view of the dental cleaning tool with the second cleaning instrument in the operable position;

FIG. 5 is a top view of the dental cleaning tool with the second cleaning instrument in the operable position;

FIG. 6 is a perspective view of a dental cleaning tool with the third cleaning instrument in the operable position and the second cleaning instrument stowed within a gap in the handle;

FIG. 7 is a perspective view of the dental cleaning tool with the third cleaning instrument in the operable position;

FIG. 8 is a front side view of the dental cleaning tool with the third cleaning instrument in the operable position;

FIG. 9 is a back side view of the dental cleaning tool with the third cleaning instrument in the operable position;

FIG. 10 is a top view of the dental cleaning tool with the third cleaning instrument in the operable position;

FIG. 11 is a perspective view of the dental cleaning tool, with the second cleaning instrument and the third cleaning instrument removed from the handle;

FIG. 12 is a perspective view of the second cleaning instrument, the connector, and the third cleaning instrument of the dental cleaning tool;

FIG. 13 is a front side view of the second cleaning instrument, the connector, and the third cleaning instrument of the dental cleaning tool;

FIG. 14 is a back side view of the second cleaning instrument, the connector, and the third cleaning instrument of the dental cleaning tool;

FIG. 15 is a top view of the second cleaning instrument, the connector, and the third cleaning instrument of the dental cleaning tool;

FIG. 16 is a perspective view of the first cleaning instrument and the handle of the dental cleaning tool;

FIG. 17 is a front side view of the first cleaning instrument and the handle of the dental cleaning tool;

FIG. 18 is a back side view of the first cleaning instrument and the handle of the dental cleaning tool;

FIG. 19 is a top view of the first cleaning instrument and the handle of the dental cleaning tool;

FIG. 20 is a sectional view of the first cleaning instrument and the handle taken at line C-C shown in FIG. 14;

FIG. 21 is a sectional view of the dental cleaning tool taken at line B-B shown in FIG. 3;

FIG. 22 is an enlarged sectional view of a portion of the dental cleaning tool indicated by area D in FIG. 21 and showing the retaining mechanism and the pivot point portion;

FIG. 23 is a sectional view of the dental cleaning tool taken at line A-A in FIG. 3 and showing the retaining mechanism; and

FIG. 24 is a side view of the dental cleaning tool illustrating four positions of the second cleaning instrument and the third cleaning instrument relative to the handle shown using phantom lines;

### DETAILED DESCRIPTION OF THE DRAWINGS

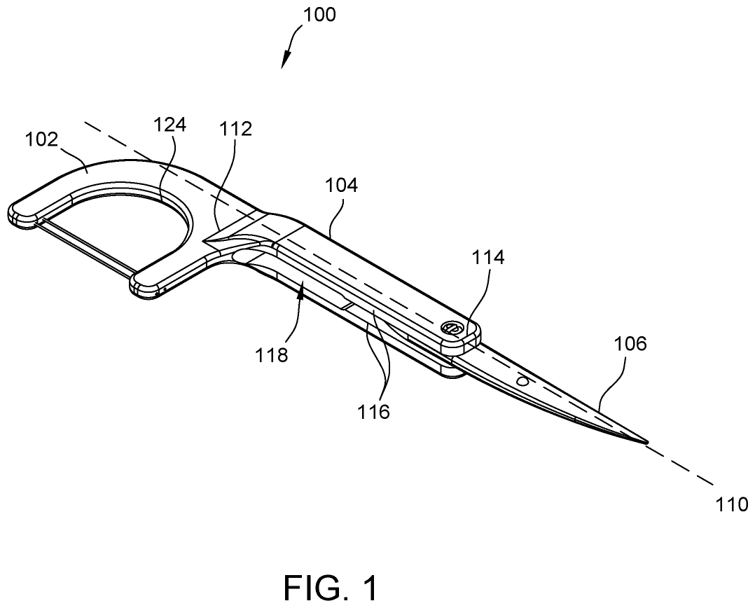

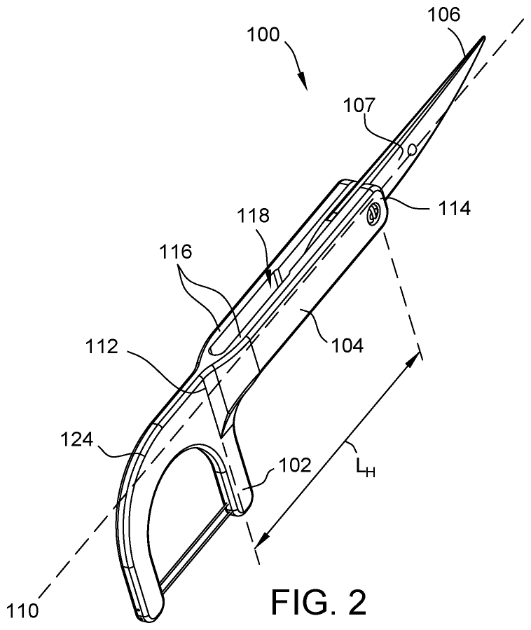

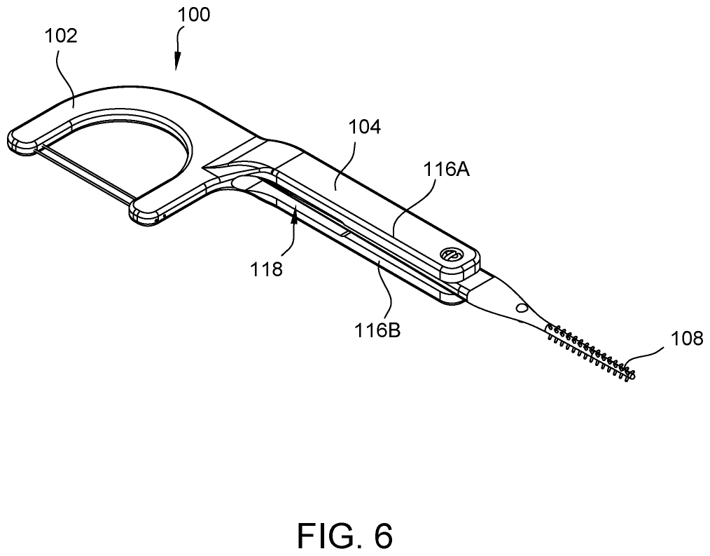

FIG. 1 is a perspective view of a suitable dental cleaning tool, indicated generally at 100. As shown in FIGS. 1 and 2, the dental cleaning tool 100 includes a first cleaning instrument 102, a handle 104, a second cleaning instrument 106, and a third cleaning instrument 108 (shown in FIG. 6). In the illustrated embodiment, the first cleaning instrument 102 is a floss assembly, the second cleaning instrument 106 is a toothpick, and the third cleaning instrument 108 is an interdental brush. In other embodiments, the dental cleaning tool 100 may include any components that enable the dental cleaning tool 100 to function as described herein. For example, in some embodiments, the dental cleaning tool 100 includes two or more cleaning instruments.

The handle 104 defines a longitudinal axis 110 of the dental cleaning tool 100 and extends from a first end 112 to a second end 114. The handle 104 includes a pair of arms 116 that define a storage gap 118 therebetween. The first cleaning instrument 102 extends from the first end 112 of the handle 104. The second cleaning instrument 106 and the third cleaning instrument 108 are rotatably attached to the handle 104 at the second end 114. In alternative embodiments, the dental cleaning tool 100 may include any handle that enables the dental cleaning tool 100 to function as described herein.

The handle 104 is sized and shaped to be held in a person's hand. The handle has a length L_{H} defined between the first end 112 and the second end 114. The length L_{H} may be in a range of about 15 millimeters (mm) to about 45 mm. In alternative embodiments, the handle 104 may be any size that enables the dental cleaning tool 100 to function as described herein.

The dental cleaning tool 100 may be formed in any suitable manner and of any suitable material. For example, the dental cleaning tool 100 may be formed from metal, wood, plastic, and/or combinations thereof. In some embodiments, one or more of the cleaning instruments 102, 106, 108 and the handle 104 may be a different material than the other components. In one preferred embodiment, the entire dental cleaning tool 100 is molded or otherwise formed from resilient synthetic material, such as, but not limited to, plastic or metal.

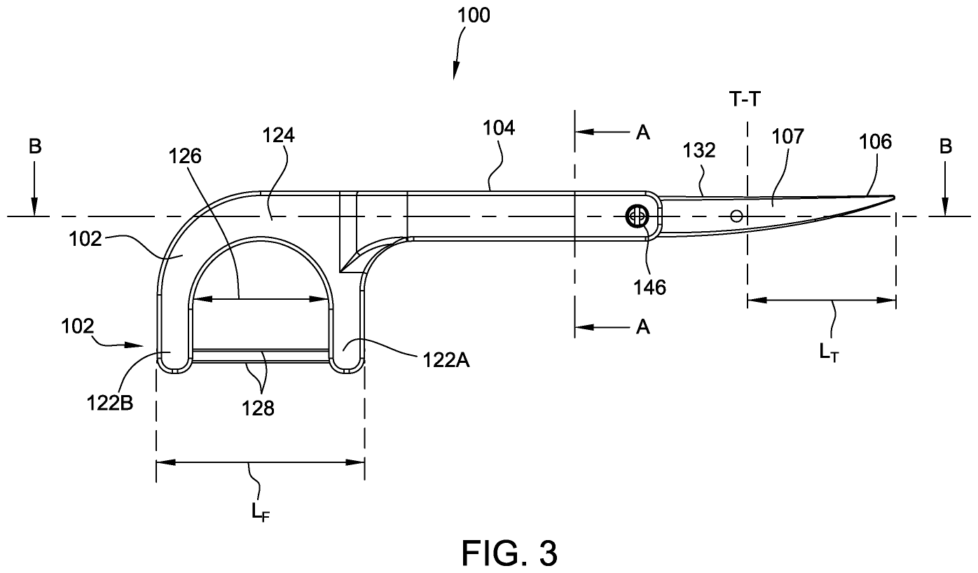

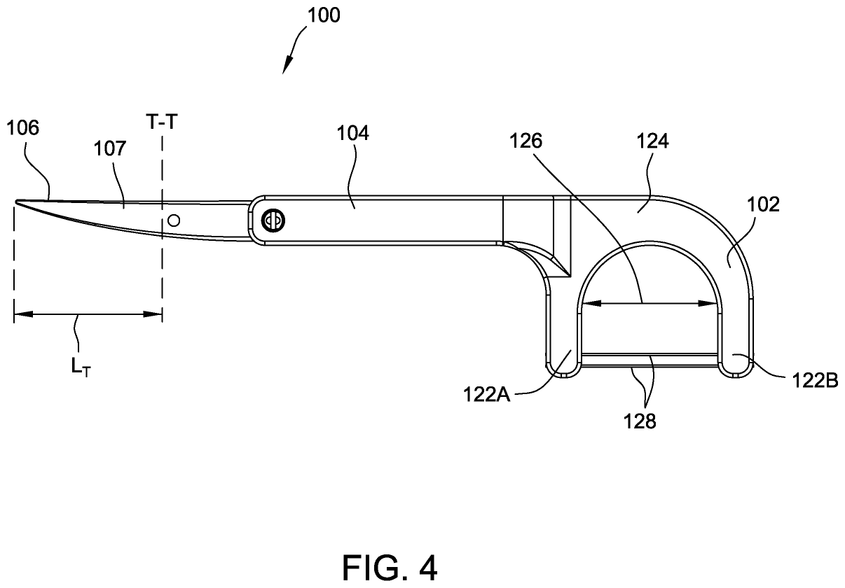

Referring to FIGS. 3 and 4, the first cleaning instrument 102 includes a first arm 122A, a second arm 122B, and a base 124 connecting the first arm 122A and the second arm 122B. The first arm 122A and the second arm 122B are substantially perpendicular to the longitudinal axis 110 and are generally parallel to each other. The base 124 extends between the first arm 122A and the second arm 122B such that the first cleaning instrument 102 has a U-shape. In alternative embodiments, the first cleaning instrument 102 is any shape that enables the dental cleaning tool to operate as described herein.

The first arm 122A and the second arm 122B are spaced apart in a direction perpendicular to the longitudinal axis 110 and a space 126 is defined therebetween. In one suitable embodiment, the dental cleaning tool 100 includes at least one strand of floss 128 that spans the space 126 and is attached to and extends between the first arm 122A and the second arm 122B. The floss 128 is held in tension across the space 126 and may be positioned between teeth to facilitate removing or loosening food remnants or other debris when inserted between the teeth. In the illustrated embodiment, the first cleaning instrument 102 includes two strand of floss 128 spanning the space 126 between the first arm 122A and the second arm 122B in a generally parallel relationship with each other. In other embodiments, the first cleaning instrument 102 can include more or fewer stands of floss 128 without departing from some aspects of this disclosure.

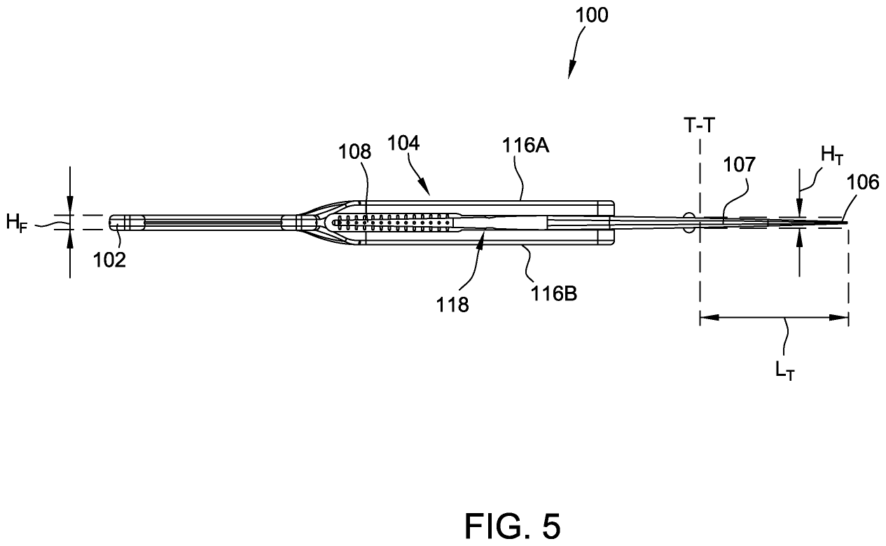

As shown in FIG. 5, the first cleaning instrument 102 has a thickness H_{F}. The thickness H_{F} is greater than the thickness of the floss 128. In addition, the thickness H_{F} is sufficient such that arms 122 are substantially rigid and retain the position of the floss 128 during use of the first cleaning instrument 102. For example, in some embodiments, the thickness H_{F} is in a range of about 1.0 millimeter (mm) to about 3.5 mm. In alternative embodiments, the first cleaning instrument 102 may have any thickness H_{F} that enables the cleaning tool to function as described herein.

The first cleaning instrument 102 has a length L_{F} defined between the second end 114 of the handle 104 and the outer side of the first arm 122A. The length may be in a range of about 10 mm to about 30 mm. In alternative embodiments, the first cleaning instrument 102 may be any size that enables the dental cleaning tool 100 to function as described herein.

In reference to FIGS. 3-5, the second cleaning instrument 106 is a toothpick and includes a substantially straight shaft 107 with a tapered end. The toothpick is configured to facilitate removing or loosening food remnants or other debris from hard-to-reach locations within the person's mouth (e.g., between teeth). In alternative embodiments, the second cleaning instrument 106 can be any suitable cleaning instrument which allows the dental cleaning tool 100 to function as described herein.

The second cleaning instrument 106 has a length L_{T} defined between the tip of the second cleaning instrument and a reference line T-T at a proximal end of the second cleaning instrument. For example, the length L_{T} may be in a range of about 5 millimeters (mm) to about 25 mm. In reference to FIG. 5, the second cleaning instrument 106 has a thickness H_{T}, at the reference line T-T. The thickness H_{T} may be in a range of about 0.6 mm to about 2.5 mm. In alternative embodiments, the second cleaning instrument 106 may be any size that enables the cleaning tool 100 to function as described herein.

Referring again to FIGS. 1-5, the second cleaning instrument 106 may be positioned in an operable position in which the second cleaning instrument 106 extends outward beyond the second end 114 of the handle 104 for use. When the second cleaning instrument 106 is in the operable position, the third cleaning instrument 108 is in a stowed position in which the third cleaning instrument 108 is contained within the storage gap 118 (shown in FIG. 5).

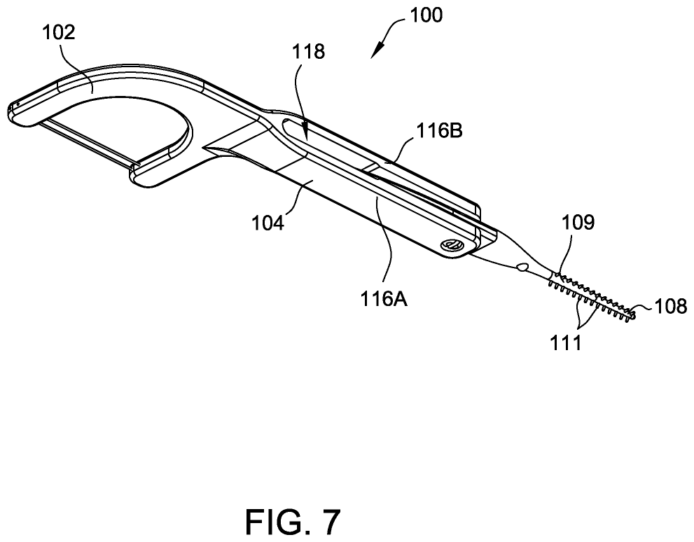

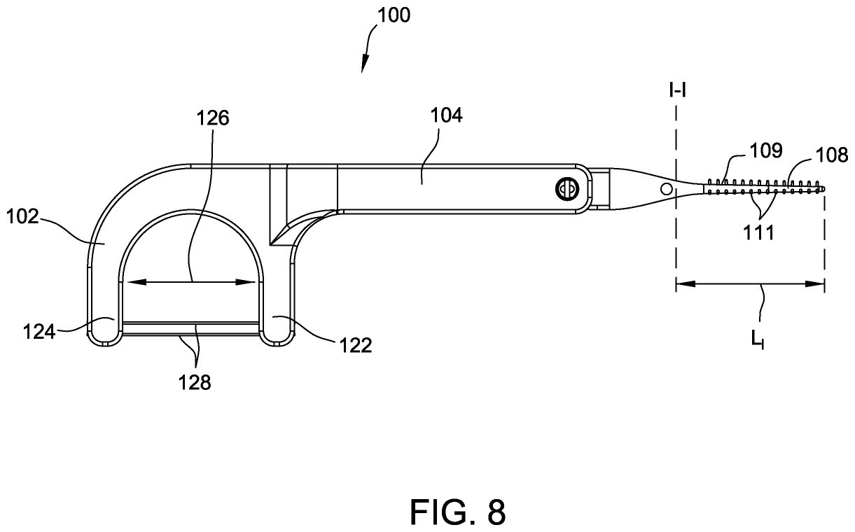

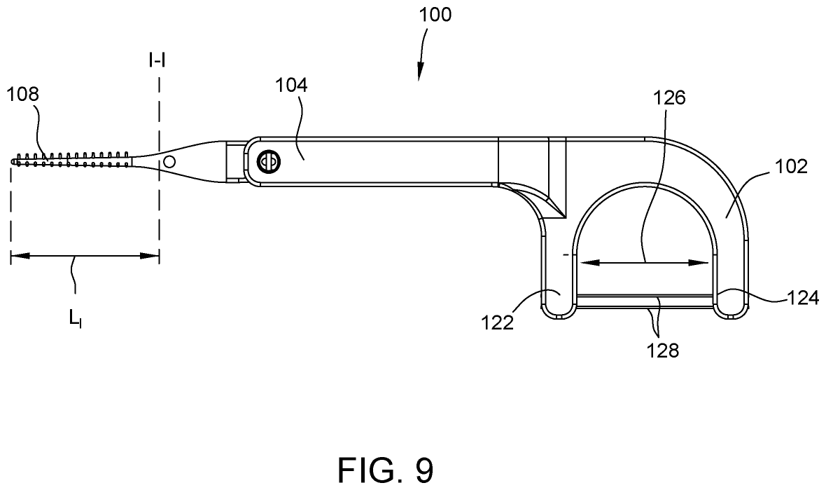

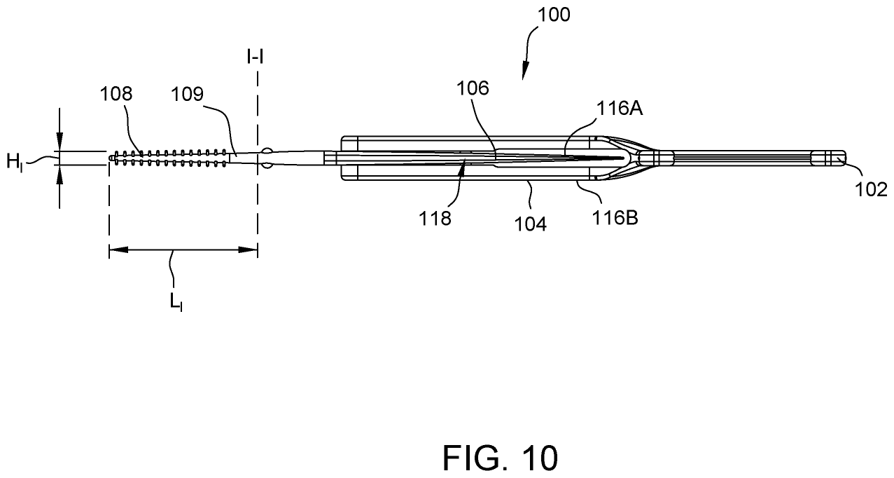

Referring to FIGS. 6-11, the third cleaning instrument 108 may be positioned in an operable position in which the third cleaning instrument 108 extends outward beyond the second end 114 of the handle 104 for use. When the third cleaning instrument 108 is in the operable position, the second cleaning instrument 106 is in a stowed position in which the second cleaning instrument 106 is contained within the storage gap 118 (shown in FIG. 10). In this embodiment, the third cleaning instrument 108 is an interdental cleaning member and includes a rod 109 and bristles 111 extending radially outward from the rod. In one embodiment, the bristles 111 of the interdental cleaning member are fabricated from nylon, and are spaced continuously along a length and a circumference of the rod to form a cylindrical brush. In some embodiments, the bristles of the bristled cleaning member are arranged in a series of rows, each extending along the length of the third cleaning instrument 108, and spaced equidistant from each other about the circumference of the third cleaning instrument. In alternative embodiments, the third cleaning instrument 108 can be any cleaning instrument which allows the dental cleaning tool 100 to function as described herein.

The third cleaning instrument 108 has a length L_{I} defined between the tip of the third cleaning instrument 108 and a reference line I-I at a proximal end of the third cleaning instrument 108. For example, the length L_{I} may be in a range of about 5 millimeters (mm) to about 25 mm. In reference to FIG. 10, the third cleaning tool has a thickness of H_{I}, at the reference line I-I. The thickness of H_{I} may be in a range of about 0.6 mm to about 2.5 mm. In alternative embodiments, the third cleaning instrument 108 is any size that enables the cleaning tool 100 to function as described herein.

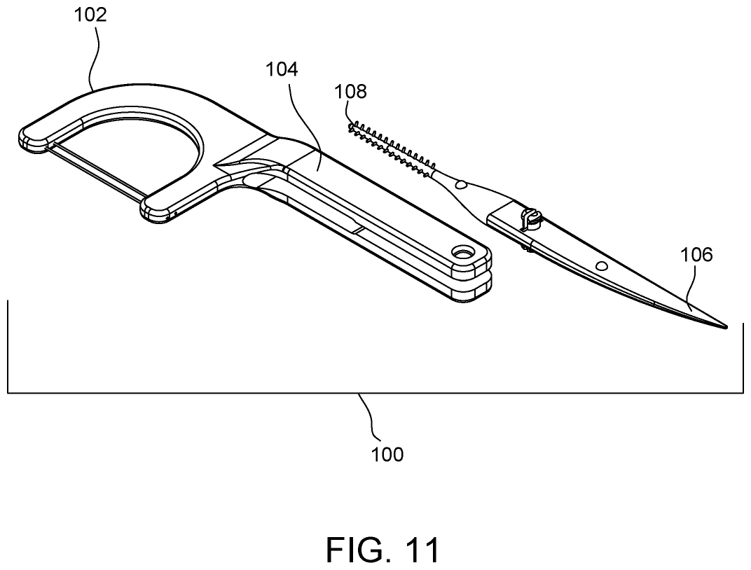

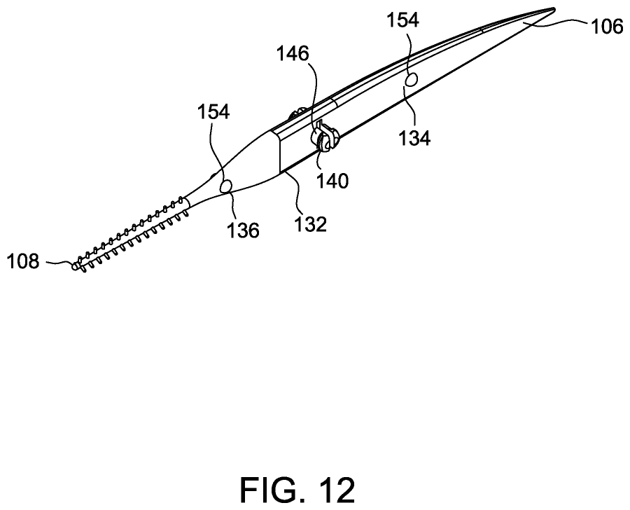

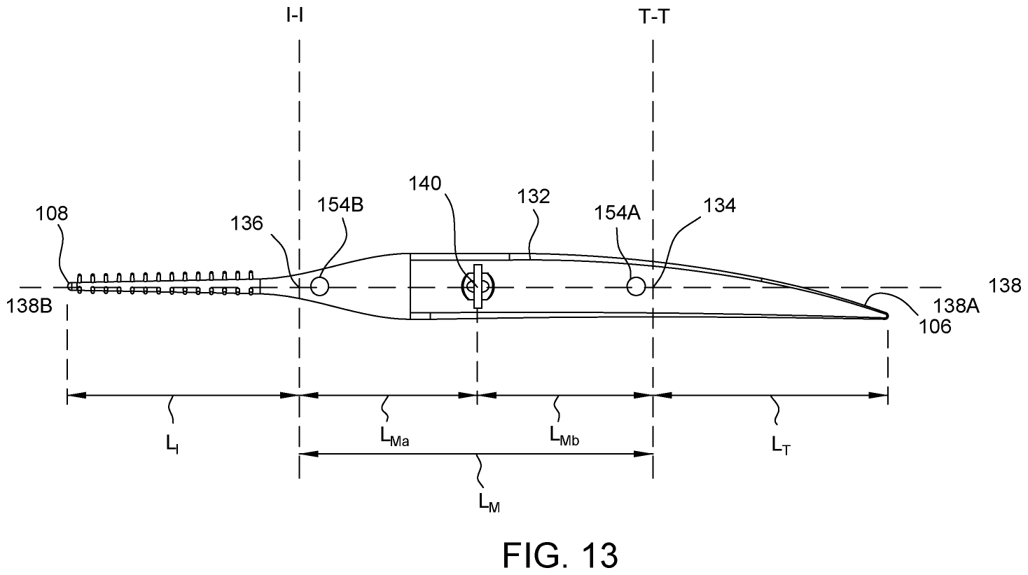

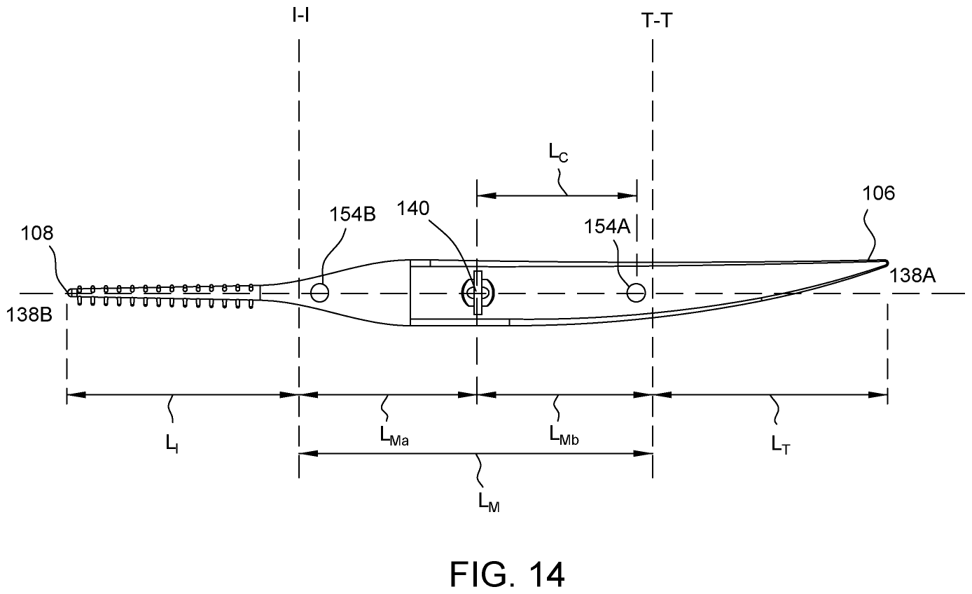

In reference to FIGS. 11-15, the second cleaning instrument 106 and the third cleaning instrument 108 are connected by a connector 132. The connector 132 extends from a first end 134 to a second end 136 along a connector axis 138. The second cleaning instrument 106 is attached to the first end 134 and the third cleaning instrument 108 is attached to the second end 136. In other embodiments, the second cleaning instrument 106 and the third cleaning instrument 108 may be connected by any suitable connector. For example, in some embodiments, the connector 132 may be curved and/or angled. In further embodiments, the connector 132 may be flexible to allow the second cleaning instrument 106 and/or the third cleaning instrument 108 to be positioned relative to each other and the handle.

The second cleaning instrument 106 has a first axis 138A that extends from the first end 134 to the proximal tip of the second cleaning instrument 106. The third cleaning instrument 108 has a second axis 138B that extends from the second end 136 of the connector 132 to the proximal tip of the third cleaning instrument 108. In this illustrated embodiment, the first axis 138A, the second axis 138B and the connector axis 138 are coincident. In addition, the second cleaning instrument 106 and the third cleaning instrument 108 are arranged substantially opposite each other along the connector axis 138. In alternative embodiments, the first axis 138A, the second axis 138B and the connector axis 138 can be any suitable axes that allow the dental cleaning tool 100 to function as described herein.

The connector 132 has an overall a length L_{M}, defined between the reference line T-T and the reference line I-I. As described further herein, the connector 132 is configured to rotate about a pivot point 140 located along the length L_{M} between the first end 134 and the second end 136. The second cleaning instrument 106 is located a length L_{Ma} away from the pivot point 140. The third cleaning instrument 108 is located at a length L_{Mb} from the pivot point 140. In some embodiments, the length L_{Ma} and the length L_{Mb} are equal. The connector 132 is sized to facilitate the respective instrument 106, 108 being positionable relative to the handle. For example, the lengths L_{Ma} and L_{Mb} are sufficient to allow each instrument 106, 108 to extend beyond the second end 136 in the operable position and still fit within the gap 118 in the handle 104 in the stowed position. For example, the length L_{Ma} may be in a range of about 5.0 millimeters (mm) to about 20 mm. The length L_{Mb} may be in a range of about 5.0 millimeters (mm) to about 20 mm. In alternative embodiments, the connector 132 may be a different size without departing from some aspects of the disclosure.

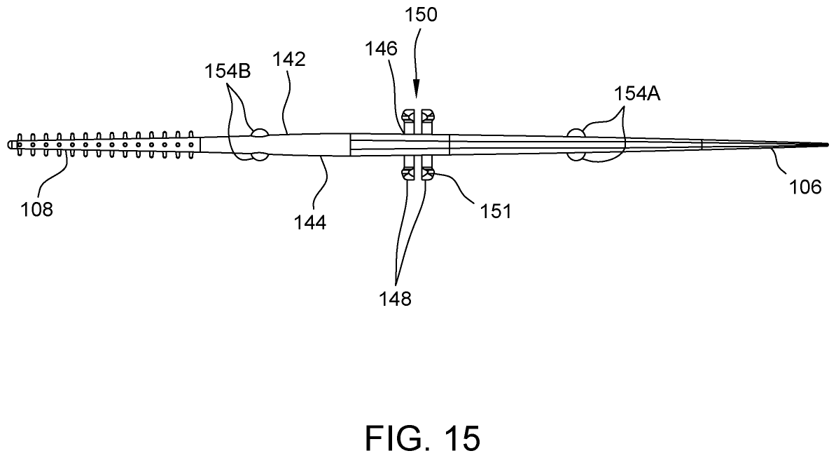

In reference to FIG. 15, the connector 132 further includes a first side 142 and a second side 144. In the illustrated embodiment, the connector 132 also includes a coupling mechanism 146 at the pivot point 140. The coupling mechanism 146 includes a first pair of prongs 148 extending outward from the first side 142 and a second pair of prongs 148 extending outward from the second side 144. The prongs 148 of each pair of prongs 148 are separated by a gap 150. Each prong 148 includes a protrusion 152 on a distal end of the prong 148 with a width larger than a width of a base of the prong 148. The coupling mechanism 146 is configured to rotatably attach the connector 132 to the handle 104 (shown in FIG. 1). In alternative embodiments, the connector 132 may include any coupling mechanism 146 that enables the cleaning tool 100 to function as described herein.

Moreover, the connector 132 further includes at least one protrusion, broadly a retaining mechanism, 154 formed on both the first end 134 and the second end 136 of coupling mechanism 146. The protrusions 154 are configured to engage the handle 104 and retain the second cleaning instrument 106 and the third cleaning instrument 108 in desired positions, e.g., the operable or stowed positions, relative to the handle 104. In the illustrated embodiment, a first pair of protrusions 154A is formed at the first end 134 of the connector 132 and a second pair of protrusions 154B is formed at the second end 136 of the connector 132. The protrusions 154A and 154B are located at a distance L_{c} away from the pivot point 140 and are positioned along the longitudinal axis 110. The first protrusions 154A are located on the connector 132 on the opposite side of the pivot point 140 from the second cleaning instrument 106 and, thus, retain the second cleaning instrument 106 in the operable positon. The second protrusions 154B are located on the connector 132 on the opposite side of the pivot point 140 from the third cleaning instrument 108 and, thus, retain the third cleaning instrument 108 in the operable position. The protrusions 154A, 154B are hemispherical and extend outward from the first side 142 and the second side 144 in a direction perpendicular to the longitudinal axis 110 (shown in FIG. 1). In alternative embodiments, the connector 132 may include any suitable retaining mechanism that enables the cleaning tool 100 to function as described herein.

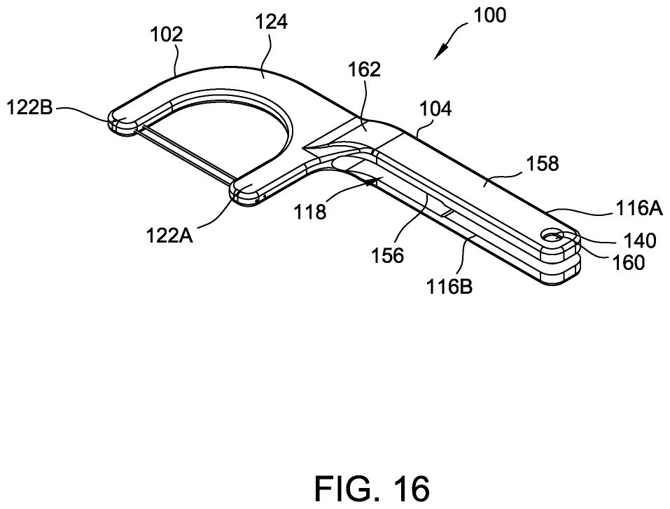

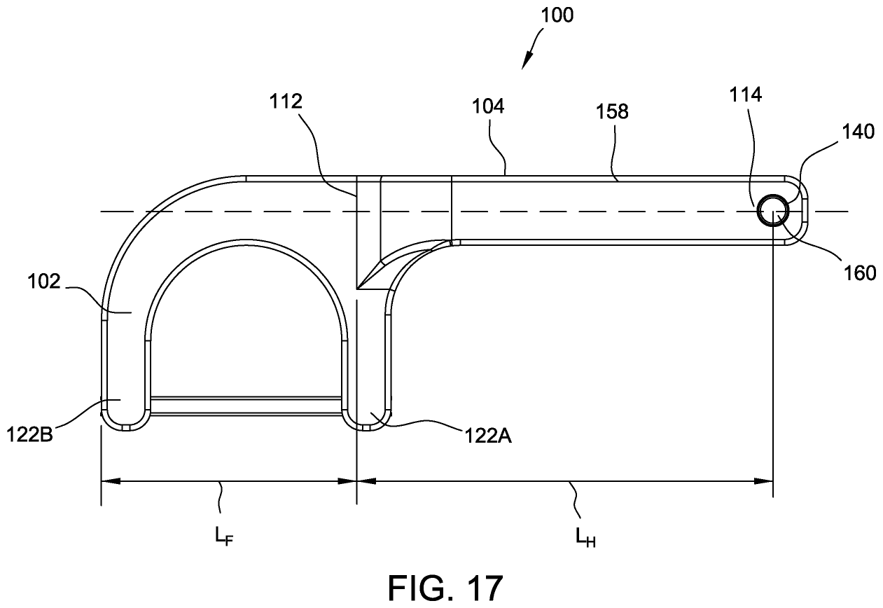

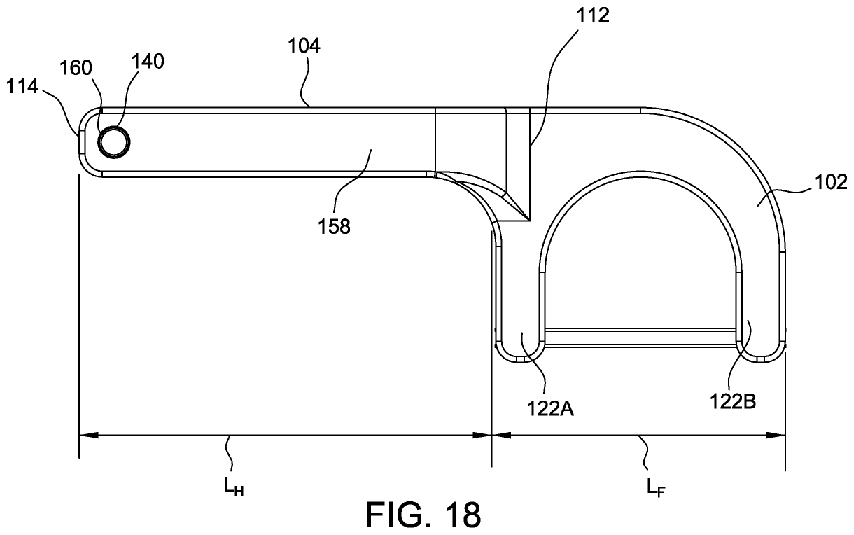

Referring to FIGS. 16-20, the first arm 116A and second arm 116B of the handle 104 extend along the longitudinal axis 110 and are spaced apart in a direction perpendicular to the longitudinal axis along substantially their entire length. Each arm 116 includes an inner surface 156 and an outer surface 158. A width H_{g} of the storage gap 118 is defined between the inner surfaces 156 of the opposed arms 116A and 116B. The arms 116A, 116B are connected by a base 162 at proximal ends such that the handle 104 has a U-shape. In alternative embodiments, the handle 104 may have any shape that enables the dental cleaning tool to function as described herein.

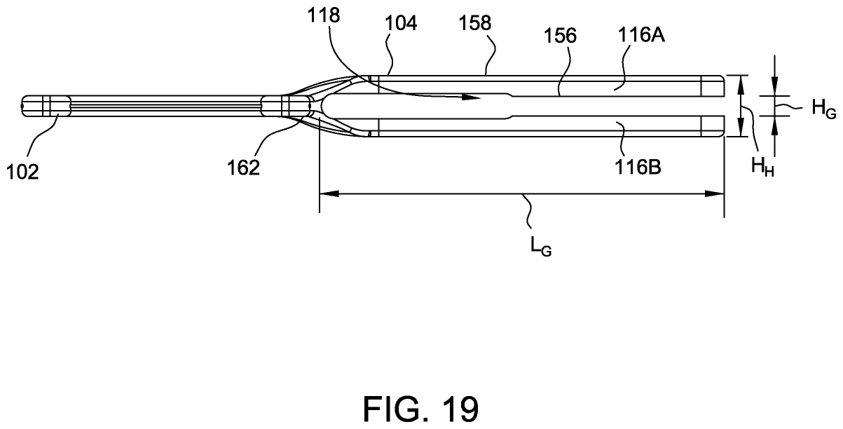

In reference to FIG. 19, the storage gap 118 has a length L_{G} defined between the base 162 and the distal end of the arms 116A and 116B. Moreover, the handle 104 has a width H_{H} defined between the outer surfaces 158 of the arms 116. The width H_{H} is greater than the width H_{G} of the storage gap 118 and is sufficient to provide rigidity and support to the handle through the length Lg. The storage gap 118 includes open sides between the arms 116A and 116B to receive the second cleaning instrument 106 (shown in FIG. 1) and the third cleaning instrument 108 (shown in FIG. 1) and allow the instruments to pass into and out of the storage gap 118 from either side. In alternative embodiments, the handle 104 may define any storage gap 118 that enables the dental cleaning tool 100 to operate as described herein.

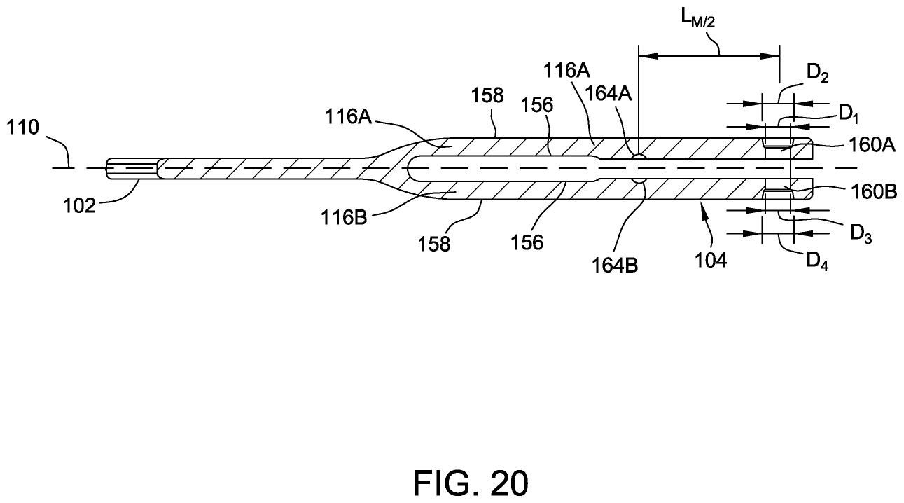

Referring to FIG. 20, a first opening 160A is defined by the first arm 116A and extends from the inner surface 156 to the outer surface 158 of the first arm 116A. A second opening 160B is defined by the second arm 116B and extends from the inner surface 156 to the outer surface 158 of the second arm 116B. The openings 160A and 160B are located at the pivot point 140 on each arm 116A and 116B. Referring to FIG. 20, the first opening 160A has a first diameter D₁ at the inner surface 156 and a second diameter D₂ at the outer surface 158. The second opening 160B has a third diameter D₃ at the inner surface 156 and a second diameter D₄ at the outer surface 158. In the illustrated embodiment, the second diameter D₂ is greater than the first diameter D₁ and the fourth diameter D₄ is greater than the third diameter D₃. Accordingly, the openings 160 are configured to receive the coupling mechanism 146 (shown in FIG. 15).

In addition, the handle 104 includes at least one concave detent 164A formed on the inner surface 156 on the first arm 116A and at least one concave detent 164B formed on the inner surface 156 of the second arm 116B. The concave detent 164A and 164B are located at a distance L_{c} away from the pivot point 140. The concave detents 164A and 164B are positioned along the longitudinal axis 110 and are configured to receive the protrusions 154 and retain the second cleaning instrument 106 and the third cleaning instrument 108 in the desired positions.

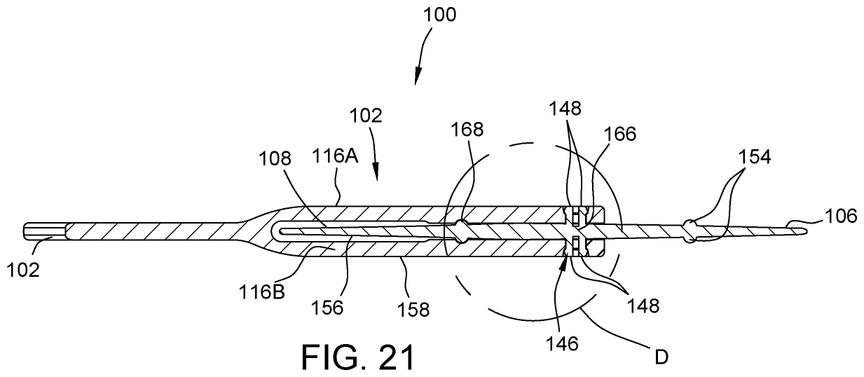

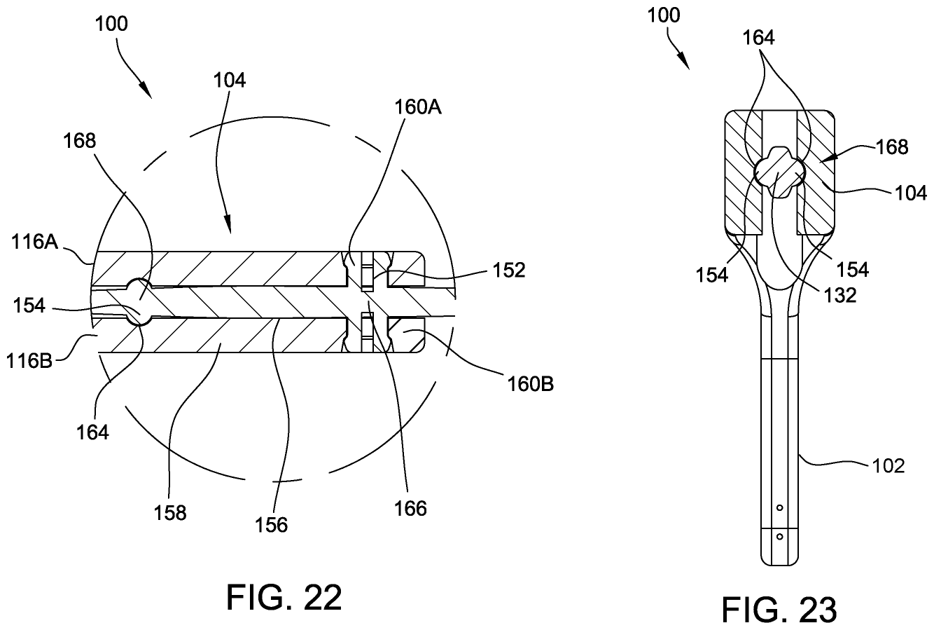

Referring to FIGS. 21-22, during assembly of the dental cleaning tool 100, the coupling mechanism 146 is configured to press fit into the opening 160 to form a rotational joint 166. Specifically, the prongs 148 compress together to allow the coupling mechanism 146 to fit through the smaller diameter portion of the openings 160 and the prongs 148 spread apart to engage the handle 104 when the prongs 148 are in the larger diameter portion of the openings 160. The rotational joint 166 is configured to allow the connector 132, and the second cleaning instrument 106 and the third cleaning instrument 108 connected to the connector 132, to rotate relative to the handle 104. The rotational joint 166 is further configured to prevent removal of the connector 132, the second cleaning instrument 106, and the third cleaning instrument 108 from the handle 104. The rotational joint 166 is formed by the press fit of the prongs 148 into the first opening 160A. The protrusions 152 are configured to engage with the outer surface 158 of the handle 104 defining the second opening 160B. When the prongs 148 are engaged in the openings 160, the prongs 148 are free to rotate within the openings. Accordingly, the rotational joint 166 is configured to allow 360° rotation of the connector 132 relative to the handle 104. In other suitable embodiments, the coupling mechanism 146 and the opening 160 may be any shape that allows the rotational joint 166 to function as described here in herein. In further embodiments, the connector 132 may be coupled to the handle 104 in any suitable manner. For example, in some embodiments, the coupling mechanism 146 may include a hinge, a bearing, a rotatable shaft, and any other suitable joint.

FIG. 23 is a cross section of the dental cleaning tool 100 taken at a reference line A-A (shown in FIG. 3) that is perpendicular to the longitudinal axis 110. A retaining mechanism 168 is configured to mechanically resist rotation of the connector 132, the second cleaning instrument 106, and the third cleaning instrument 108 relative to the handle 104 when the second cleaning instrument 106 and the third cleaning instrument 108 are in either the operable position or the stowed position. For example, the retaining mechanism 168 includes the protrusions 154 on the connector 132 which are configured to engage with at least one concave detent 164 on the handle 104. The concave detents 164 and the protrusions 154 are located such that the connector axis 138 is aligned with the longitudinal axis 110 when the protrusions 154 are engaged with the concave detents 164. In addition, the retaining mechanism 168 retains the connector 132 in either a first position in which the second cleaning instrument 106 is in an operable position and the third cleaning instrument 108 is in a stowed position, and a second position in which the second cleaning instrument 106 is in the stowed position and the third cleaning instrument 108 is in the operable position. As such, the second cleaning instrument 106 and the third cleaning instrument 108 are restricted from unintentionally being moved from the stowed position to the operable position, or from being unintentionally moved from the operable position to the stowed position. Moreover, when in the stowed position, either one of the second cleaning instrument 106 or third cleaning instrument 108 is substantially flush with the handle 104 such that use of the first cleaning instrument 102 remains unimpeded. In other embodiments, the connector 132, the second cleaning instrument 106, and/or the third cleaning instrument 108 are retained in any position that enables the dental cleaning tool 100 to operate as described herein.

The concave detents 164 and the protrusions 154 have corresponding shapes to facilitate engagement of the concave detents 164 and the protrusions 154. Specifically, in the illustrated embodiment, the detents 164 and the protrusions 154 have curved surfaces with substantially equal radiuses. In other suitable embodiments, the concave detents 164 and the protrusions 154 may be any shape that allows the retaining mechanism to function as described herein. In some embodiments, the protrusions 154 and the detents 164 may be positioned on any of the handle 104, the second cleaning instrument 106, and the third cleaning instrument 108.

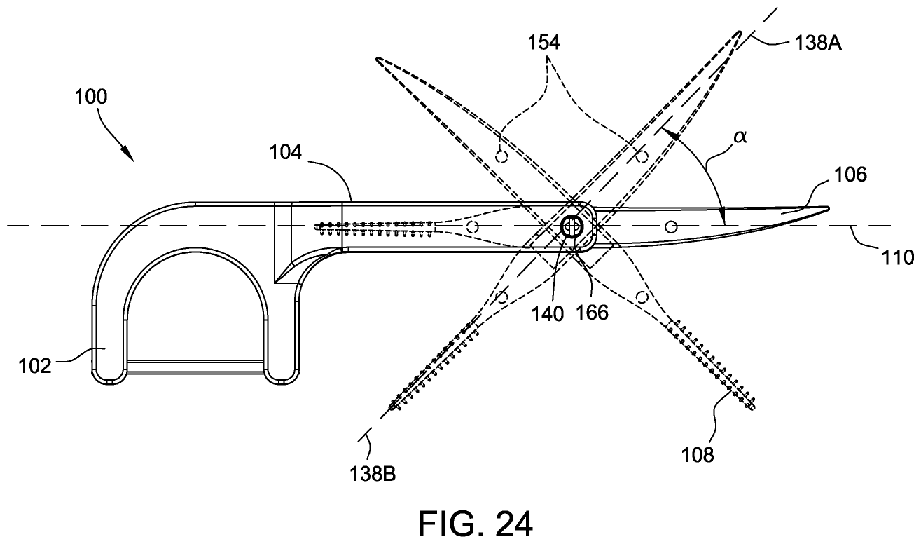

FIG. 24 is a side view of the dental cleaning tool 100 showing the second cleaning instrument 106 and the third cleaning instrument 108 selectively positioned in the operable position, the stowed position, and positions between the operable position and the stowed position using phantom lines. The second cleaning instrument 106 and the third cleaning instrument 108 are manually rotatable relative to the handle 104 such that a user can selectively rotate the second cleaning instrument 106 and the third cleaning instrument 108 about the pivot point 140 in a plurality of positions relative to the handle 104. For example, the user can apply a force to either the second cleaning instrument 106 or the third cleaning instrument 108, to rotate either the second cleaning instrument 106 or the third cleaning instrument 108 in a clockwise or a counterclockwise motion relative to the handle 104. An angle α is measured in a counter clockwise direction from the longitudinal axis 110 to the first axis 138A of the second cleaning instrument 106. The angle α is different for each position of the second cleaning instrument 106 and the third cleaning instrument 108. The angle α can be any angle in a range of 0° to 360° because the second cleaning instrument 106 and the third cleaning instrument 108 are positionable 360° relative to the handle 104. The angle α is 0° when the second cleaning instrument 106 is in the operating position in which the second cleaning instrument extends from the second end 114. In addition, when angle α is 0°, the third cleaning instrument 108 is in the stowed position because the third cleaning instrument 108 opposes the second cleaning instrument 106. Additionally, when angle α is 0°, the second protrusions 154B are positioned to engage the detents 164 and retain the second cleaning instrument 106 in the operable position and the third cleaning tool 108 in the stowed position. When the second cleaning instrument 106 is positioned such that angle α is 180°, the second cleaning instrument 106 is in the stowed position and the third cleaning instrument 108 is in the operable position. The first protrusions 154A engage the detents 164 to retain the third cleaning instrument 108 in the operable position while additionally retaining the second cleaning instrument 106 in the stowed position. The protrusions 154 will become disengaged from the detents 164 when the user applies a force to either the second cleaning instrument 106 or the third cleaning tool 108 to overcome the engagement force of the retaining mechanism 168.

Referring to FIGS. 2, 3, 13, and 24, a user of the dental cleaning tool 100 is able to grasp the handle 104 and rotate the connector 132 relative to the handle to selectively deploy either one of the second cleaning instrument 106 or the third cleaning instrument 108 from the stowed position to the operable position. The length L_{T} and the length L_{I} are sufficiently long such that the second cleaning instrument 106 and the third cleaning instrument 108, when in the operable position, extend past the second end 114 of the handle 104. Moreover, the second cleaning instrument 106 and the third cleaning instrument 108 while in the operable position, are unimpeded by the first cleaning instrument 102 or any other part of the dental cleaning tool 100. The total length of the dental cleaning tool 100 when the second cleaning instrument 106 is in the operable position is the sum of the lengths L_{H}, L_{F}, and L_{T}. The total length of the dental cleaning tool 100 when the third cleaning tool 108 is in the operable position is the sum of the lengths L_{H}, L_{F}, and L_{I}.

In addition, the user is able to position either of the second cleaning instrument 106 or the third cleaning instrument 108 in the stowed position. When in the stowed position, the second cleaning instrument 106 or the third cleaning instrument 108 is contained, with minimal clearance, within the storage gap 118. The length L_{G} of the storage gap 118 is slightly larger than the sum of the length L_{T} and the length L_{Mb} or the sum of the length L_{I} and the length L_{Ma}. Accordingly, the second cleaning instrument 106 or the third cleaning instrument fits completely within the storage gap 118 when in the stowed position. The clearance between the handle 104 and either of the second cleaning instrument 106 or the third cleaning instrument 108 positioned in the storage gap 118 is designed to create an overall compact dental cleaning tool 100.

During use of the dental cleaning tool 100, a user may selectively use any of the first cleaning instrument 102, the second cleaning instrument 106, and the third cleaning instrument 108 to clean a person's teeth. For example, the user may grip the handle 104 and position the first cleaning instrument 102 proximate teeth to clean the teeth. Specifically, the user may position the floss strands 128 of the floss between two adjacent teeth to floss the teeth. Alternatively, the user may grip the handle 104 with either the second cleaning instrument 106 or the third cleaning instrument 108 in position for use. The user may select either the second cleaning instrument 106 or the third cleaning instrument 108 for use by positioning either the second cleaning instrument or the third cleaning instrument in the operable position. Once the selected instrument 106, 108 is in the operable position, the retaining mechanism will maintain the second cleaning instrument 106 or the third cleaning instrument 108 in the operable position relative to handle 104 while in use. Additionally, the retaining mechanism and the configuration of the storage gap 118 prevents the user from unintentionally deploying either the second cleaning instrument 106 or the third cleaning instrument 108 from the stowed position when the user grips the handle 104 while the dental cleaning tool 100 is in use. The user can position the second cleaning instrument 106 relative to a person's teeth to facilitate removal of food and debris from between teeth when the second cleaning instrument 106 is in the operable position. Further, the user can position the third cleaning instrument 108 relative to the user's teeth to clean the teeth and remove food particle or debris from around and in between a person's teeth.

In addition, the handle 104 is configured to facilitate use and transportation of the dental cleaning tool 100. The handle 104 includes areas of increased thickness to facilitate the user grasping the handle while the dental cleaning tool 100 is in use. The handle 104 also functions as storage for at least one of the second cleaning instrument 106 or the third cleaning instrument 108 such that at least one of the second cleaning instrument or the third cleaning instrument is shielded when in the stowed position. Shielding one of the second cleaning instrument 106 or the third cleaning instrument 108 allows the dental cleaning tool 100 to have a reduced overall size and allows the user to easily transport the dental cleaning tool, such as in a pocket or a purse.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dental cleaning tool comprising:
a handle defining a longitudinal axis and a storage gap, the handle having a first end and an opposing second end;
a first cleaning instrument extending from the first end of the handle;
a second cleaning instrument positionable between a stowed position in which the second cleaning instrument is positioned within the storage gap and an operable position in which the second cleaning instrument extends from second end of the handle;
a third cleaning instrument positionable between a stowed position in which the third cleaning instrument is positioned within the storage gap and an operable position in which the third cleaning instrument extends from the second end of the handle; and
a connector having a first end and an opposing second end and defining a connector axis, wherein the second cleaning instrument is connected to the first end of the connector and the third cleaning instrument is connected to the second end of the connector, the connector is rotatably connected to the handle for selectively positioning the second cleaning instrument and the third cleaning instrument relative to the handle, wherein the second cleaning instrument is in the operable position when the third cleaning instrument is in the stowed position and the third cleaning instrument is in the operable position when the second cleaning instrument is in the stowed position.

2. The dental cleaning tool in accordance with claim 1, wherein the connector extends along the longitudinal axis when one of the second cleaning instrument and the third cleaning instrument is positioned within the storage gap.

3. The dental cleaning tool in accordance with claim 1, wherein the storage gap has a length greater than a length of each of the second cleaning instrument and the third cleaning instrument such that the second cleaning instrument and the third cleaning instrument fit entirely within the storage gap.

4. The dental cleaning tool in accordance with claim 1, wherein the first cleaning instrument comprises a floss assembly including a first arm, a second arm extending substantially perpendicularly relative to the longitudinal axis, and at least one floss strand extending between the first arm and the second arm.

5. The dental cleaning tool in accordance with claim 1, wherein the second cleaning instrument includes a toothpick.

6. The dental cleaning tool in accordance with claim 5, wherein the third cleaning instrument includes an interdental cleaning member.

7. The dental cleaning tool in accordance with claim 1, wherein the connector includes a coupling mechanism, wherein the coupling mechanism includes a pair of prongs that are sized to fit in an opening defined by the handle.

8. The dental cleaning tool in accordance with claim 7, wherein the prongs each include a protrusion on a distal end that has a diameter larger than a base of the respective prong.

9. The dental cleaning tool in accordance with claim 8, wherein the handle includes at least one arm having an inner surface, an outer surface, and an opening defined therebetween, the opening having a first diameter at the inner surface and a second diameter at the outer surface, wherein the first diameter is smaller than the second diameter.

10. The dental cleaning tool in accordance with claim 9, wherein the prongs are configured for insertion into the opening to form a rotational joint, and wherein the protrusions are configured to engage with the second surface when the prongs are positioned in the opening.

11. The dental cleaning tool in accordance with claim 10, wherein the connector is attached to the handle at a pivot point at the rotational joint, and wherein the connector is rotatable 360° about the pivot point.

12. The dental cleaning tool in accordance with claim 1, wherein the dental cleaning tool comprises a retaining mechanism to retain one of the second cleaning instrument and the third cleaning instrument in the operable position while the other of the second cleaning instrument and the third cleaning instrument is in the stowed position.

13. The dental cleaning tool in accordance with claim 12, wherein the retaining mechanism includes at least one concave detent formed on an inner surface of the handle.

14. The dental cleaning tool in accordance with claim 13, wherein the retaining mechanism includes at least one protrusion formed on the connector, the protrusion being sized and shaped to engage with the concave detent and resist rotation of the connector relative to the handle.

15. The dental cleaning tool in accordance with claim 14, wherein the at least one protrusion and the at least one concave detent are positioned to retain the second cleaning instrument in the operable position when the third cleaning instrument is in the stowed position such that the second cleaning instrument and the third cleaning instrument are aligned with the longitudinal axis of the handle.

16. The dental cleaning tool in accordance with claim 1, wherein the handle includes a first arm and a second arm extending along the longitudinal axis and defining the storage gap therebetween.

17. A dental cleaning tool comprising:
a handle defining a longitudinal axis, the handle having a first end and an opposing second end, wherein the handle includes a first arm and a second arm defining a storage gap therebetween;
a first cleaning instrument attached to the first end of the handle;
a second cleaning instrument at the second end of the handle;
a rotational joint attaching the second cleaning instrument to the handle, wherein the rotational joint allows the second cleaning instrument to rotate relative to the handle for selective positioning of the second cleaning instrument between a stowed position in which the second cleaning instrument is positioned in the storage gap between the first and second arms and an operable position in which the second cleaning instrument extends beyond the second end of the handle; and
a retaining mechanism configured to retain the second cleaning instrument in at least one of the operable position and the stowed position.

18. The dental cleaning tool in accordance with claim 17, wherein the first arm includes an inner surface and an outer surface, wherein the retaining mechanism includes a concave detent in the inner surface.

19. The dental cleaning tool in accordance with claim 18, wherein the retaining mechanism further includes at least one protrusion configured to engage the concave detent.

20. The dental cleaning tool in accordance with claim 17, further comprising a third cleaning instrument attached to the second cleaning instrument and configured to rotate relative to the handle when the second cleaning instrument is switched between the operable position and the stowed position.

21. The dental cleaning tool in accordance with claim 20, wherein the third cleaning instrument is positionable between a stowed position in which the third cleaning instrument is positioned in the storage gap between the first and second arms and an operable position in which the third cleaning instrument extends beyond the second end of the handle.

22. A method for assembling a dental cleaning tool, the method comprising:
providing a handle defining a longitudinal axis and a storage gap, the handle having a first end and an opposing second end;
attaching a first cleaning instrument to the first end of the handle;
attaching a second cleaning instrument to a first end of a connector, wherein the second cleaning instrument is positionable between a stowed position in which the second cleaning instrument is positioned within the storage gap and an operable position in which the second cleaning instrument extends from second end of the handle;
attaching a third cleaning instrument to a second end of the connector, wherein the third cleaning instrument is positionable between a stowed position in which the third cleaning instrument is positioned within the storage gap and an operable position in which the third cleaning instrument extends from the second end of the handle; and
rotatably connecting the connector to the handle to allow the second cleaning instrument and the third cleaning instrument to rotate relative to the handle.

23. The method in accordance with claim 22, wherein rotatably connecting the connector to the handle comprises positioning a pair of prongs on the connector in an opening in the handle.

24. The method in accordance with claim 22, wherein attaching the first cleaning instrument to the first end of the handle comprises integrally forming the first cleaning instrument and the handle.

25. The method in accordance with claim 22 further comprising positioning at least one of a protrusion and a detent on the handle to retain the second cleaning instrument in the operable position.

26. The method in accordance with claim 22 further comprising forming first and second arms of the handle, the first and second arms extending along the longitudinal axis and defining the storage gap therebetween, wherein the first and second arms each have a length greater than the length of the second cleaning instrument and the third cleaning instrument.
